(19) United States
(12) Patent Application Publication
(10) Pub. No.: US 2008/0140635 A1
(43) Pub. Date: Jun. 12, 2008

(54) Methods for providing categorical and/or subcategorical information from a query

(76) Inventor: Frank John Williams, Los Alamitos, CA (US)

Correspondence Address: Frank John Williams, 2711 Saint Albans dr., Los Alamitos, CA, 90720, US

(21) Appl. No.: 11/998,121

(22) Filed: Nov. 27, 2007

Related U.S. Application Data
(60) Provisional application No. 60/861,169, filed on Nov. 27, 2006.

(51) Int. Cl. G06F 17/30

(52) U.S. Cl. 707/3

(57) ABSTRACT

A series of methods and systems for searching, providing, displaying and suggesting information identifying at least one category and/or subcategory relevant to the information in a query are described. In one embodiment, results comprise links providing further and/or relevant information.

### RELATED APPLICATIONS

This patent application claims the benefit of U.S. provisional patent application Ser. No. 60/861,169 filed 2006 Nov. 27 by the present inventor

### BACKGROUND

1. Field of the Invention

The present invention relates generally to several methods for searching, retrieving and providing information in general. More particularly, to a method for providing categories and subcategories of the information in a query.

2. Description of Related Art

The search engine is one the most important and valuable tools that websites offers to prospective clients to quickly find the items they are looking for. However, particularly the category search engines, force the user to go through a series of links and steps before the product or group containing the product is found or displayed, while limiting the search based on the customer knowledge and skill. For example, a user is looking to find information of a particular model of copy machine. The category search engine forces the user to select between professional office machines and home office machines. The guessing user selects the home option and then is forced to select between digital and analog. Once again the user guesses or opts for digital. Then in digital the user must once more select between laser and bubble jet, to which the user selects laser. Then once more, the user is greeted with a choice of multifunctional or simplex. Finally the user chooses the multifunctional link laser link and is presented with an entire family of home laser multifunction machines. Accordingly and hopefully, the user must then look through the records before finding the apparatus of choice and its corresponding literature to find the print speed per page of the desired machine. Consequentially, current ecommerce search engines can quickly and efficiently discourage and frustrate a potential client.

### SUMMARY OF THE INVENTION

The present invention teaches certain benefits in use and construction which give rise to the objectives and advantages described below. The methods embodied by the present invention overcome the limitations and shortcomings encountered when searching for items through category search engines and/or requesting detailed information of an apparatus or others. The present invention discloses a series of methods for providing and searching detailed item information, while optionally and automatically incorporating and/or displaying pre-categories, categories and subcategories custom to the query and/or item. Furthermore, the order of displaying records can readily match the order of the query's information, thus prioritizing and/or matching the order of the user's request and informational demand.

### OBJECTS AND ADVANTAGES

A primary objective inherent in the above described method of use is to provide a means and methods for searching and providing information specific, but not limited to apparatuses by means not taught by the prior arts and further advantages and objectives not taught by the prior art. Accordingly, several objects and advantages of the invention are,

Another objective is to enhance ecommerce,

Another objective is to reduce user confusion,

Another objective is to find information regardless of the user's skill and knowledge.

A further objective is to enable websites and information providers to utilize any type of synonym or similar information to identify the item regardless of the skill of the clientele.

A further objective is to permit superior searching accuracy.

A further objective is to permit detail searches of information.

A further objective is to remove or reduce irrelevance.

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present method of use. In such drawings:

FIG. 1 is a non-limiting illustration of an Inventory Eeggi (or collection of different smaller eeggis) specifically designed to handle most ecommerce and/or apparatus type queries;

FIG. 2 is another non-limiting exemplary illustration of several input queries mining or retrieving information from several Inventory Eeggis;

FIG. 3A and FIG. 3B are non-limiting exemplary illustrations of the inventive method for automatically displaying subcategories of the query's data. Both examples implement a single Target Identifying Eeggi for supplying and displaying its subcategories automatically based upon each Input Query's content.;

FIG. 4 is another non-limiting exemplary illustration of a variation of the inventive method displaying categories and subcategories custom to the query's data implementing a reference Subcategory Links Database;

FIG. 5 is a non-limiting exemplary illustration of the inventive method implementing the category and/or subcategory links to provide further information;

### DETAILED DESCRIPTION

The above described drawing figures illustrate the described methods and use in at least one of its preferred, best mode embodiment, which is further defined in detail in the following description. Those having ordinary skill in the art may be able to make alterations and modifications of what is described herein without departing from its spirit and scope. Therefore, it must be understood that what is illustrated is set forth only for the purposes of example and that it should not be taken as a limitation in the scope of the present system and method of use.

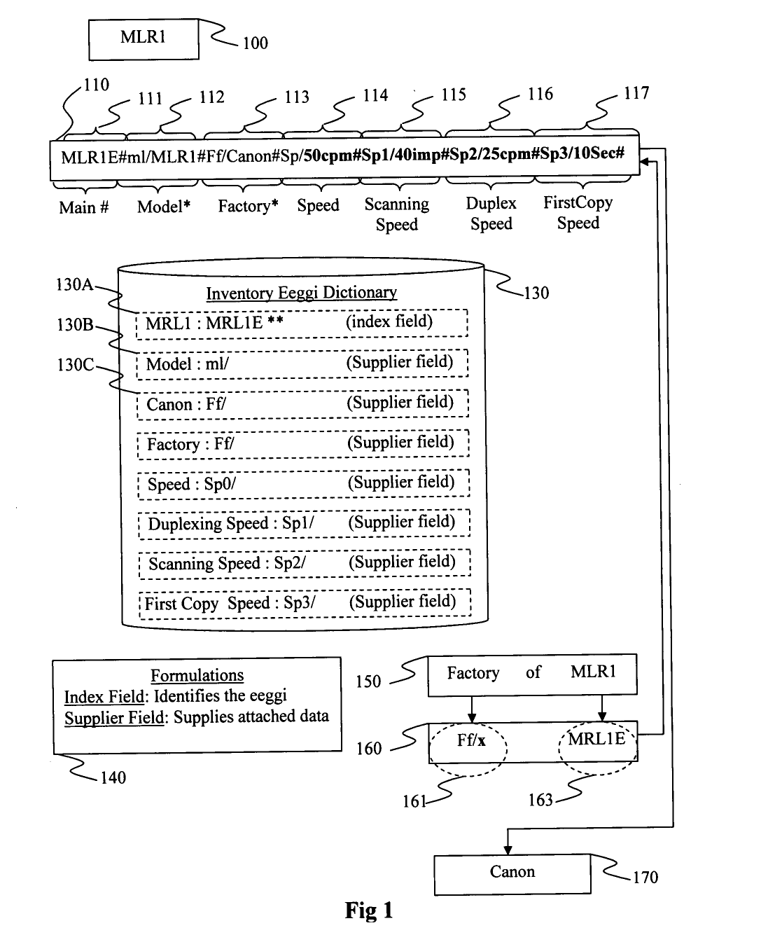

FIG. 1 is a non-limiting illustration of an “Inventory Eeggi” (or collection of different smaller eeggis) specifically designed to handle most ecommerce and/or apparatus type queries. As illustrated the Item Word 100 (FIG. 1) or “MLR1” identifying a particular model and type of copier, is being identified by its corresponding Inventory Eeggi 110 (FIG. 1), which as illustrated, is comprised of several information fields thus forming a single string of different types of information of the copy machine. Please note, the “#” symbol attaches (or separates) the many fields of the eeggi such as the Main Eeggi Identifying Information 111 (FIG. 1), the Model Information 112 (FIG. 1), the Manufacturer or Factory Information 113 (FIG. 1), the Copier Speed Information 114 (FIG. 1), the Scanning Speed Information 115, the Duplex Speed Information 116 (FIG. 1), and the First Copy Speed Information 117 (FIG. 1). Just below is the Inventory Eeggi Dictionary 130 (FIG. 1) or “IED” for short, which provides the translation or identification that every word has. In addition the IED also displays the type of each field of the Inventory Eeggi. For example, the First Word 130A (FIG. 1) or “MRL1” is identified by its respective identifier or “MRL1E” and field's type or “index.” In similar fashion the Second Word 130B (FIG. 1) or “model” has its identifier or “ml/” and the type of field or “supplier.” The Third Word 130C (FIG. 1) or “Canon” has its identifier or “Ff/” and the type of field or “Supplier.” The Formulations Table 140 (FIG. 1) depicts the formulations that apply to each eeggi field type. For example, it says that the Index Field is used only for identifying or finding the Inventory Eeggi; while the Supplier Field provides or displays its associated data (information to the right of the “/” symbol). Accordingly, an input query 150 (FIG. 1) is converted into its respective Inventory Eeggi Query 160 (FIG. 1) or IEQ for short, which implements the IED 130 (FIG. 1). As illustrated, the IEQ 160 (FIG. 1) is composed of two eeggi field information; wherein the “Ff/” 161 (FIG. 1) is going to retrieve the field's data in the Inventory Eeggi 110 (FIG. 1) and the “MRL1E” 163 (FIG. 1) is going to identify or find the Inventory Eeggi that the “Ff/” will retrieve the information from. Accordingly, the IEQ 160 (FIG. 1) retrieves the word “Canon” contained in the “Ff/” Supplier field of the eeggi; while “MRL1E” (index field) was used to identify the Inventory Eeggi. Consequentially, only “Canon” is retrieved from the exemplary Inventory Eeggi 110 (FIG. 1) as illustrated by the Results Display 170 (FIG. 1). Please note, to facilitate the present illustration and disclosure, an “x” has been added to the supplier field “Ff/” or “Ff/x” thus helping exemplify the “x” as a variable retrieving or representing any attached or contained value and/or information.

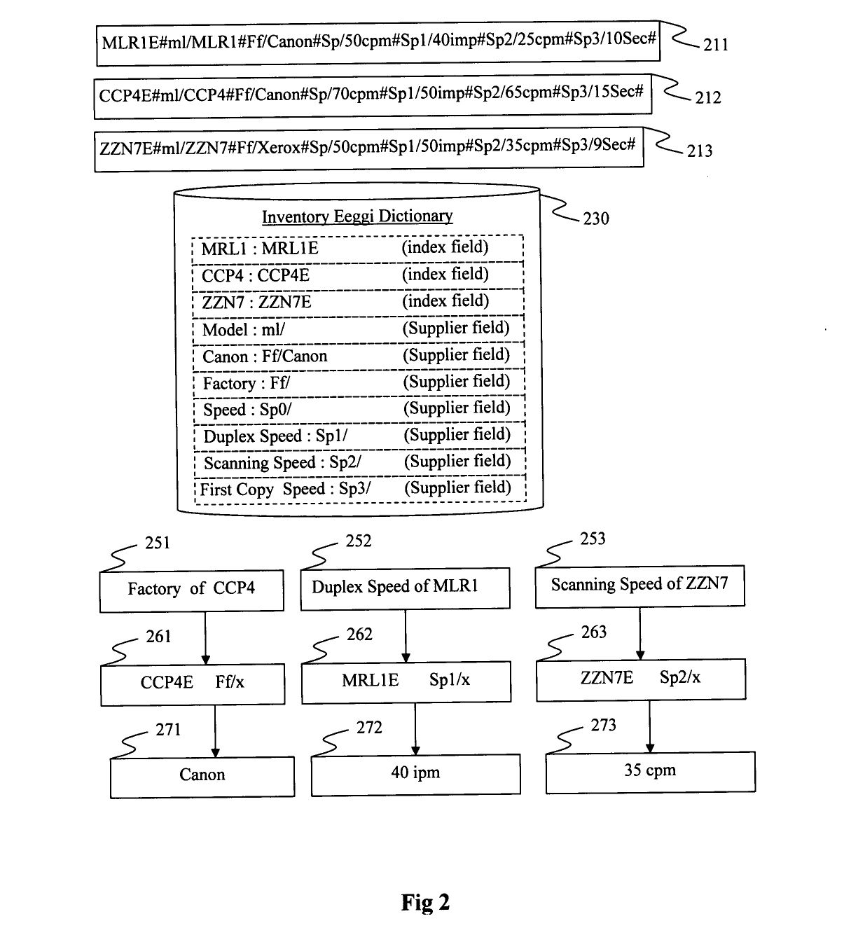

FIG. 2 is another non-limiting exemplary illustration of several input queries mining or retrieving information from several Inventory Eeggis. In FIG. 2, there are three Target Inventory Eeggis or TIE for short, such as the First TIE 211 (FIG. 2), the Second TIE 212 (FIG. 2), and the Third TIE 213 (FIG. 2). The IED 230 (FIG. 2) is used to convert input queries into their respective IEQs. Accordingly, the First Input Query 251 (FIG. 2) or “Factory of CCP4” is converted into its IEQ 261 (FIG. 2) or “CCP4E” which identifies the Second TIE 212 (FIG. 2) and “Ff/” which retrieves the information of the Ff/field of the Second TIE. Appropriately, the retrieved “Ff/” field information (Canon) is displayed in the First Results Display 271 (FIG. 2). The Second Input Query 252 (FIG. 2) or “Duplex Speed of MRL1” is converted into its IEQ 262 (FIG. 2) or “MRL1E” which as an index type field is used to identify the matching eeggi or First TIE 211 (FIG. 2) and the “Sp1/” type which retrieves the information of the “Sp1/” field of the First TIE. Appropriately, the retrieved “Sp1/” field information (40 μm) is displayed in the Second Results Display 272 (FIG. 2). The Third Input Query 253 (FIG. 2) or “Scanning Speed of ZZN7” is converted into its IEQ 263 (FIG. 2) or “ZZN7E” which identifies the Third TIE 213 (FIG. 2) and “Sp2P” which retrieves the information of the “Sp2/” field (35 cpm) of the Third TIE. Appropriately, the retrieved “Sp2/” field information or “35 cpm” is displayed in the Third Results Display 273 (FIG. 2).

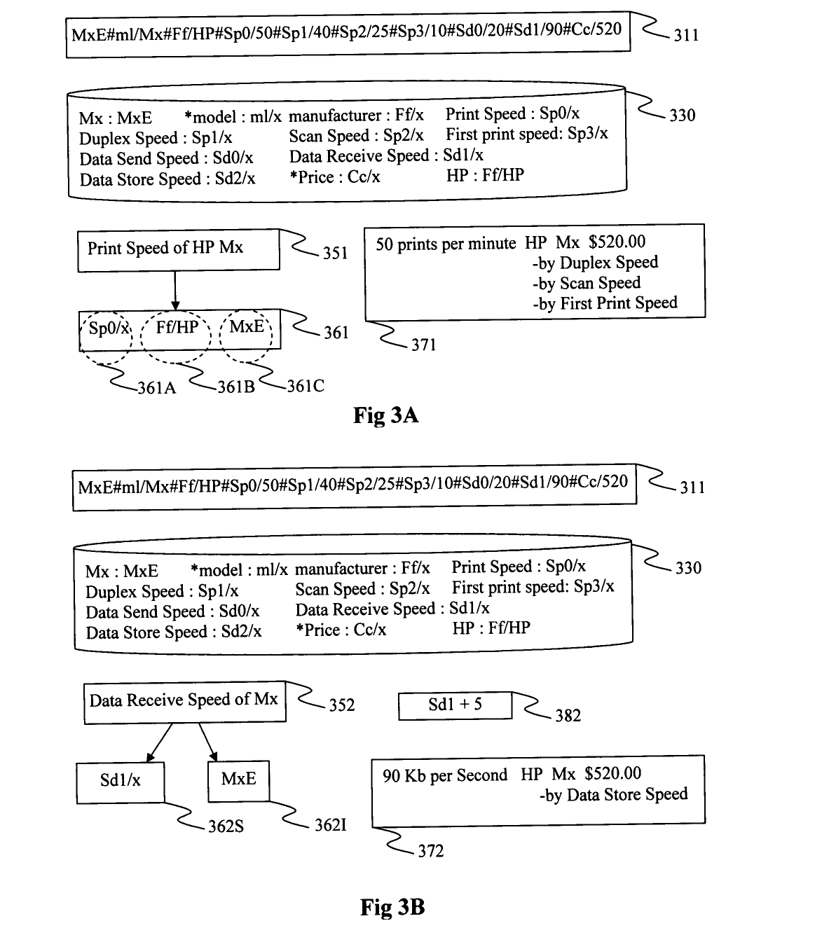

FIG. 3A and FIG. 3B are non-limiting exemplary illustrations of the inventive method for automatically displaying subcategories of the query's data. Both examples implement a single TIE for supplying and displaying its subcategories automatically based upon each Input Query's content. For example, the TIE 311 (FIG. 3A) provides the information that the Input Query 351 (FIG. 3A) identifies and/or retrieves while the Results Display 371 (FIG. 3A) illustrates prospective and relating subcategories data. Accordingly, The Input Query 351 (FIG. 3A) is converted into its respective IEQ 361 (FIG. 3A) implementing the IED 330 (FIG. 3A). Accordingly, the IEQ contains three querying fields such as the supplier field “Sp0/x” 361A (FIG. 3A) that will retrieve information from the “Sp0/” field of the TIE 311 (FIG. 3A), the match field “Ff/HP” 361B (FIG. 3A) which simply finds matching fields in the TIE; wherein the “Ff/”=“Ff/HP” (Hewlet Parckard), and index field “MxE” 361C (FIG. 3) which is used to identify the TIE 311 (FIG. 3A). Accordingly, the Results Display 371 (FIG. 3A) provides the Print Speed (Sp0/50), the manufacturer “HP,” the model “Mx” and the Price ($500.00). Please note, the manufacturer information “HP” was generated because the model field in the IED 330 (FIG. 3A) illustrates a * symbol indicating that “model” is a forced field (always to be displayed). In similar fashion, the price ($500) is displayed because of the * property of the field in the IED 330 (FIG. 3A) forcing the field's information on all results. However, three subcategory links are also displayed, such as the First Subcategory Link 381 (FIG. 3A), the Second Subcategory Link 382 (FIG. 3A), and the Third Subcategory Link 383 (FIG. 3A). As illustrated by the IED 330 (FIG. 3A), all the Speed information fields are identified and/or grouped by a “Sp” value. Accordingly, when a query retrieves a particular Sp field, the text information of all the other (not requested) Sp fields is displayed as subcategory links. For example, the Input Query 351 (FIG. 3A) requested only one Speed field (Sp0/). Consequentially, the corresponding text information of the other three Sp fields (Duplex Speed=Sp1/, Scan Speed=Sp2/, and First Print Speed=Sp3/) are displayed. FIG. 3B is another non-limiting exemplary illustration of the inventive method this time making use of several types of queries. For example, the Input Query 352 (FIG. 3B) is converted into two queries, the Supplier IEQ 362S (FIG. 3B) comprising only inquiring supplier fields, and the Index IEQ 362I (FIG. 3B) comprising only identifying index fields, both implementing at least one IED 330 (FIG. 3B). As illustrated, the Supplier IEQ 362S (FIG. 3B) contains inquiries only from supplier fields (Sd1/x); while the Index IEQ 362I (FIG. 3B) contains only identifying field data. Accordingly, the Supplier IEQ 362S (FIG. 3B) or “Sd1/x” retrieves the “Sd1/” information of the TIE 311 (FIG. 3B), and the Index IEQ 3621 (FIG. 3B) or “MxE” identifies or locates the TIE 311 (FIG. 3B) providing the information. However, in this example, the “Sd1/” is numerically modified or expanded through the Subcategory Modifier Operation 382 (FIG. 3B) to identify the others fields that will form the subcategory links. In such fashion, the value of “5” is added to the Sd1 value of the field, thus forming a value range from Sd1 to Sd6. Appropriately, the Text versions, according to the IED 330 (FIG. 3B) of every “Sd/” field (from Sd1 to Sd6, except Sd1) is to be displayed as a subcategory link. Accordingly, the Results Display 372 (FIG. 3B) displays only one subcategory link or “-by Data Store Speed” along with the response to the initial query or “90 Kb per second, HP, Mx and $520.” Please note how once again, the information from “forced” fields (not requested) is displayed, such as HP, Mx, and $520. In addition, please note, the make or display of the information the link actually displays can be generated from the IED and/or any other source of choice.

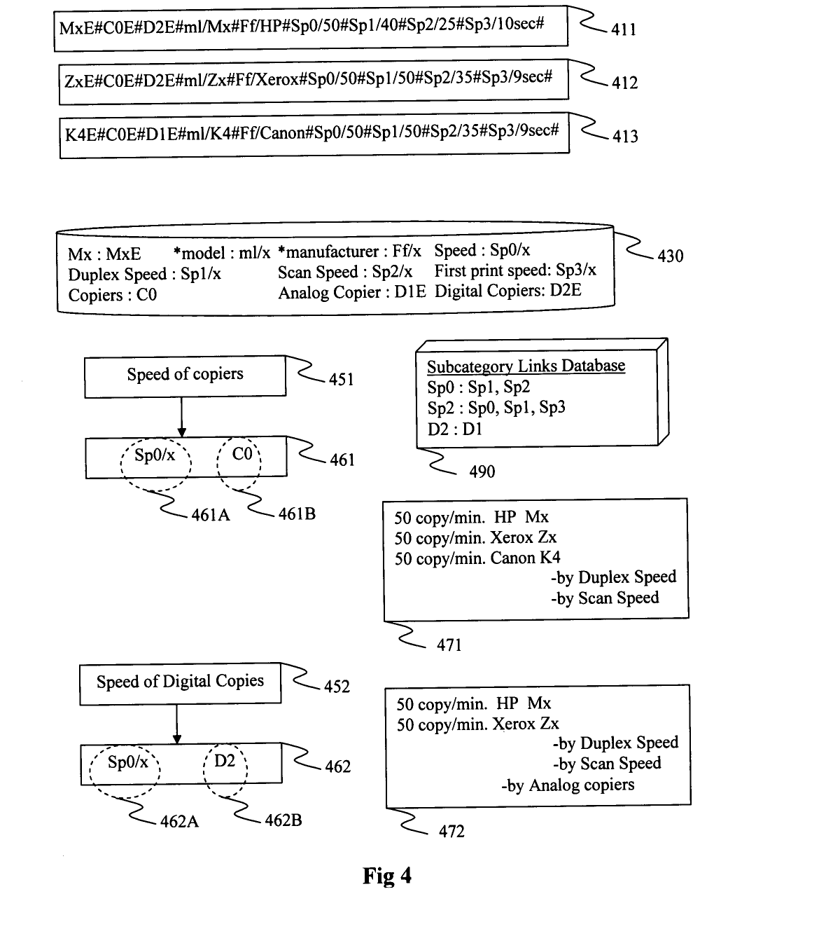

FIG. 4 is another non-limiting exemplary illustration of a variation of the inventive method displaying categories and subcategories custom to the query's data implementing a reference from the Subcategory Links Database. As illustrated, FIG. 4 has three TIE, or the First TIE 411 (FIG. 4), the Second TIE 412 (FIG. 4), and the Third TIE 413 (FIG. 4); which this time display the additional index fields of “C0E” and “DxE” (the term “x” is a variable). Accordingly, a First IEQ 451 (FIG. 4) is converted implementing the IED 430 (FIG. 4) into the First IEQ 461 (FIG. 4). Accordingly, the “Sp0/x” 461A (FIG. 4) inquiring a supply field will retrieve the information of the “Sp0” fields of the identified TIE(s); while the “C0” 461B (FIG. 4) inquiring an index field will be used to identify the TIE(s) that will supply the information. As illustrated, each TIE (First, Second, and Third) match the “C0” index field. Consequentially, each TIE produces or displays their respective “Sp0” field information. As a result, the Results Display 471 (FIG. 4) shows three copy machines with their respective forced fields and subcategory links such as “-by Duplex Speed” and “-by Scan Speed.” However, this time two subcategory links were generated thanks to the Subcategory Links Database 490 (FIG. 4) which provided the corresponding link information to the “Sp0” field of the IEQ 461 (FIG. 4). For example, the “Sp0/x” 461A (FIG. 4) field in the query, was searched in the Subcategory Links Database 490 (FIG. 4) looking for relating subcategories links. As illustrated, the Subcategory Link Database 490 (FIG. 4) identifies only two links associated to “Sp0” or “Sp1” (duplex speed) and “Sp2” (scan speed). However, the Second Input produces other categories in addition to subcategories. Accordingly, the Second Input Query 452 (FIG. 4) is converted, implementing the IED 430 (FIG. 4) into the Second IEQ 462 (FIG. 4). Accordingly, the “Sp0/x” 462A (FIG. 4) retrieves the information of the “Sp0” fields, while the “D2” 462B (FIG. 4) identifies the appropriate TIE(s). Only the First TIE 411 (FIG. 4) and the Second TIE 214 (FIG. 4) match the “D2” index field. Accordingly, their respective “Sp0” field information are retrieved and/or displayed in the Second Results Display 472 (FIG. 4). However, in this example, subcategories and categories are displayed. As illustrated by the Subcategory Links Database 490 (FIG. 4), a “Sp0/x” 462A (FIG. 4) present in the IEQ signifies the display of the corresponding links (Sp1 and Sp2). The existence of a “D2” 462B (FIG. 4) or “Digital Copiers” in the IEQ, signifies the display of the corresponding “D1” link or “Analog Copiers.” Accordingly, the subcategories and categories of the results are displayed in the Second Results Display 472 (FIG. 4)

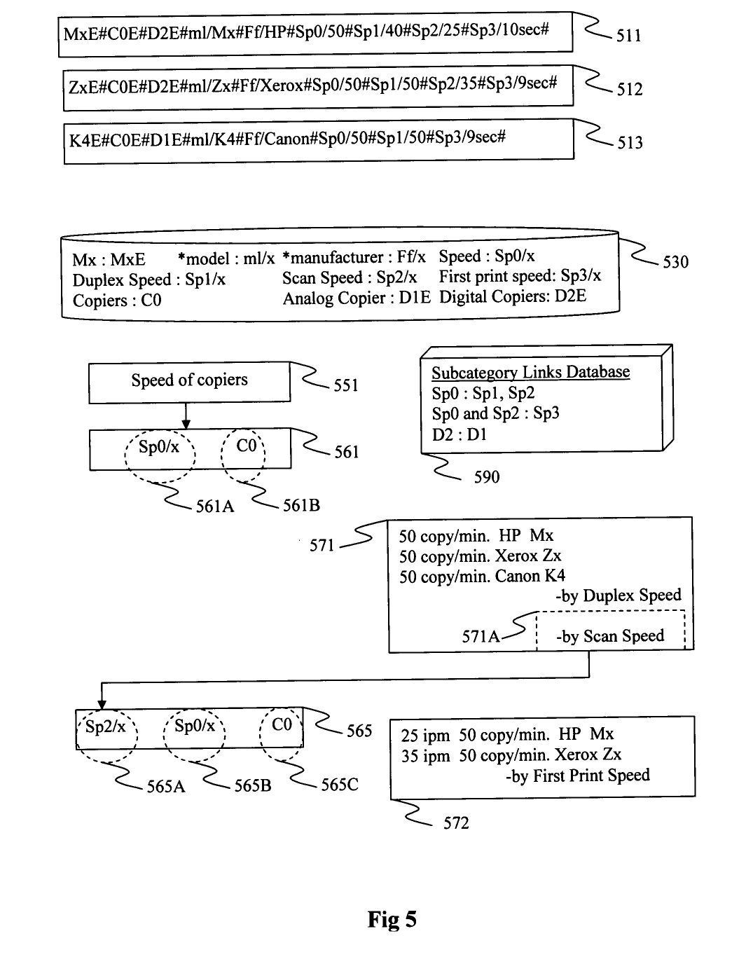

FIG. 5 is a non-limiting exemplary illustration of the inventive method implementing the category and/or subcategory links to provide further information. As illustrated, FIG. 5 has three Target Inventory Eeggis (TIE). The First TIE 511 (FIG. 4), the Second TIE 512 (FIG. 5), and the Third TIE 513 (FIG. 5). Accordingly, the Initial Query 551 (FIG. 5) is converted implementing the IED 530 (FIG. 5) into the IEQ 561 (FIG. 5). Accordingly, the “Sp0/x” 561A (FIG. 5) inquires the information of the “Sp0” of the TIEs, while the “C0” 561B (FIG. 5) identify the TIE(s) that will supply the information. As illustrated, all of the TIEs (First, Second, and Third) match the “C0” index field. Consequentially, each TIE produces or displays their respective “Sp0” field information. As a result, the Results Display 571 (FIG. 5) shows the three copy machines with their respective forced fields and subcategory links such as “-by Duplex Speed” and “-by Scan Speed.” Consequentially, clicking on the “-by Scan Speed” link 571A (FIG. 5) re-generates the IEQ (or creates a new one) to now implement the corresponding link information such as “Scan Speed” or “Sp2” fields. Accordingly, the IEQ 561 (FIG. 5) is converted and/or modified into the Subcategory IEQ 565 (FIG. 5) which as illustrated comprises the added information corresponding to the “by Scan Speed” link or “Sp2” inquiry field. Accordingly, the currently identified TIEs continue providing the new information, or a whole new IEQ 565 (FIG. 5) can be generated as illustrated by this particular example. Accordingly, the information from each of the supply fields, “Sp2/x” 565A (FIG. 5) and “Sp0/x” 565B (FIG. 5), will be retrieved from the TIE identified by the “C0” 565C (FIG. 5) identifying information. As illustrated, the retrieved “copiers” in the Second Results Display 572 (FIG. 5) display the corresponding supply field information (Sp2 or Scan Speed; and Sp0 or Speed) in addition to any information from a corresponding forced field and the corresponding subcategory or category links as identified by the Subcategory Links Database 590 (FIG. 5). Please note how in the Second Results Display 572 (FIG. 5) there are only two copiers instead of three as in the previous display. This is because the Third TIE 513 (FIG. 5) or “the Canon machine” inventory eeggi has no “Scan Speed” field since it is an Analog machine.

Noteworthy, although the disclosed inventive method disclosed in the previous figures implemented a single exemplary string or complex inventory eeggi, through indexes and others it is also possible to implement several combinations of smaller strings and/or independent fields.

The embodiments and/or enablement's described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a series of novel methods for producing, displaying and suggesting links (information) identifying categories and/or subcategories of the information in a query can be appreciated. The described methods overcome the limitations encountered by current and/or envisioned category search engines providing superior results and more detailed results, while improving ecommerce and avoiding irrelevance.

1. A method for suggesting at least one of a: category information, and subcategory information of a query, the method comprising the steps of:
a) Identifying a First information in a query; wherein said First information is identifying an element;
b) Identifying a Second information identifying said First information;
c) Identifying a Third information matching said Second information; wherein said Third information comprises at least one Fourth information of said element, and
at least one Fifth information categorically relating to said Fourth information;
d) Providing a said Fourth information;
e) Displaying an information identifying said Fifth information.
